(19) United States
(12) Patent Application Publication
(10) Pub. No.: US 2021/0197478 A1
(43) Pub. Date: Jul. 1, 2021

(54) MODULES OF THREE-DIMENSIONAL (3D) PRINTERS

(71) Applicant: Hewlett-Packard Development Company, L.P., Spring, TX (US)

(72) Inventors: Kristopher J Erickson, Palo Alto, CA (US); Spencer Barrett, Camas, WA (US); Kenneth Williams, Camas, WA (US)

(73) Assignee: Hewlett-Packard Development Company, L.P., Spring, TX (US)

(21) Appl. No.: 17/047,019

(22) PCT Filed: Aug. 27, 2018
(86) PCT No.: PCT/US2018/048062

§ 371 Date: Oct. 12, 2020

(51) Int. Cl. B29C 64/379; B29C 64/232; B29C 64/236; B29C 64/241; B33Y 10/00; B33Y 30/00; B33Y 40/00

(52) U.S. Cl. CPC B29C 64/379; B29C 64/232; B29C 64/236; B33Y 40/00; B33Y 10/00; B33Y 30/00; B29C 64/241

(57) ABSTRACT

In some examples, a module of a three-dimensional (3D) printer can include a first linear actuator, a second linear actuator, and a tool to selectively engage a part and selectively disengage from the part, where the tool is connected to the first linear actuator and the second linear actuator.

### BACKGROUND

A three-dimensional (3D) printer may be used to create different 3D objects. 3D printers may utilize additive manufacturing techniques to create the 3D objects. For instance, a 3D printer may deposit material in successive layers in a build area of the 3D printer to create a 3D object. The material can be selectively fused, or otherwise solidified, to form the successive layers of the 3D object.

### BRIEF DESCRIPTION OF THE DRAWINGS

FIG. 1 illustrates a side view of an example of a module of a 3D printer consistent with the disclosure.

FIG. 2 illustrates a side view of an example of a module of a 3D printer consistent with the disclosure.

FIG. 3 illustrates a perspective view of an example of a system consistent with the disclosure.

FIG. 4 illustrates a front view of an example of a system of a 3D printer and a pickup platform consistent with the disclosure.

FIG. 5 illustrates a perspective view of a system of a 3D printer and a member consistent with the disclosure.

FIG. 6 illustrates an example of a method consistent with the disclosure.

### DETAILED DESCRIPTION

Some 3D printers can utilize a build material to create 3D objects that has a powdered and/or granular form. The 3D printer may apply build material in successive layers in a build area to create 3D objects. The build area may include a build platform. The build material can be fused, and a next successive layer of build material may be applied to the build platform of the build area.

As used herein, the term “3D printer” can, for example, refer to a device that can create a physical 3D object. For example, a 3D printer can include a multi-jet fusion 3D printer, among other types of 3D printers. In some examples, the 3D printer can create the 3D object utilizing a 3D digital model. The 3D printer can create the 3D object by, for example, depositing a build material such as powder, and a fusing agent in a build area of the 3D printer. The build material may be deposited in successive layers in the build area and build material included in the successive layers can absorb energy from a lamp as a result of the fusing agent to fuse the successive layers to create the 3D object.

During a 3D print job of a 3D object, it may be desired to include components or parts in the 3D object being printed. For example, the 3D object may be designed to be an electronic device including electronic components. The electronic components may be desired to be placed in the 3D object, as well as the connections between those electronic components.

Manual placement of parts in a 3D object may cause undesired side effects in the 3D object. For example, the 3D print job may be delayed while parts are manually placed in the 3D object during the 3D print job. Manual placement of parts may not result in proper placement accuracy in the 3D object. Additionally, parts placed in the 3D object may not be properly prepared thermally or placed quickly enough if thermally prepared, which can cause losses in dimensional accuracy of the part and/or the 3D object, and/or warping of the placed part and/or the 3D object being printed.

Modules of 3D printers can allow for automated placement of parts in a 3D object during a 3D print job. For example, parts including electrical parts, optical parts, mechanical parts, aesthetic parts, and/or any other parts may be placed in a 3D object during a 3D print job. The parts can be placed and/or embedded in the 3D object during the 3D print job without placement accuracy issues, reduction in dimensional accuracy of the part, and/or warping of the placed part and/or warping of the 3D object. Additionally, the parts can be placed and/or embedded in the 3D object during the 3D print job of the 3D objection without substantial delay in the 3D print job. Modules of 3D printers can allow for a wide variety of 3D objects/devices to be created during a 3D print job.

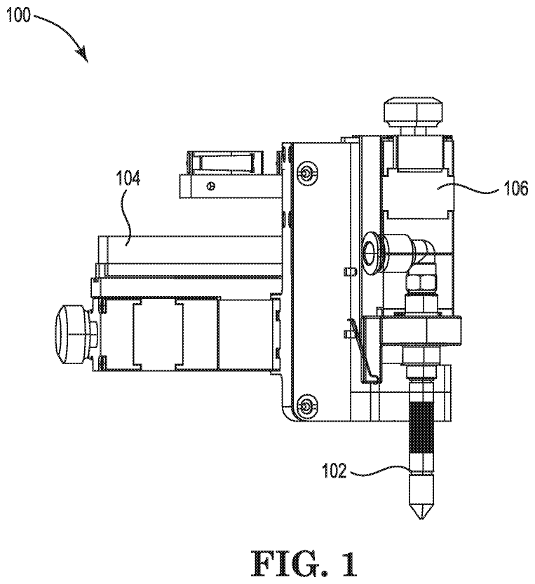

FIG. 1 illustrates a side view of an example of a module 100 of a 3D printer consistent with the disclosure. The module 100 may include a tool 102, first linear actuator 104, and second linear actuator 106.

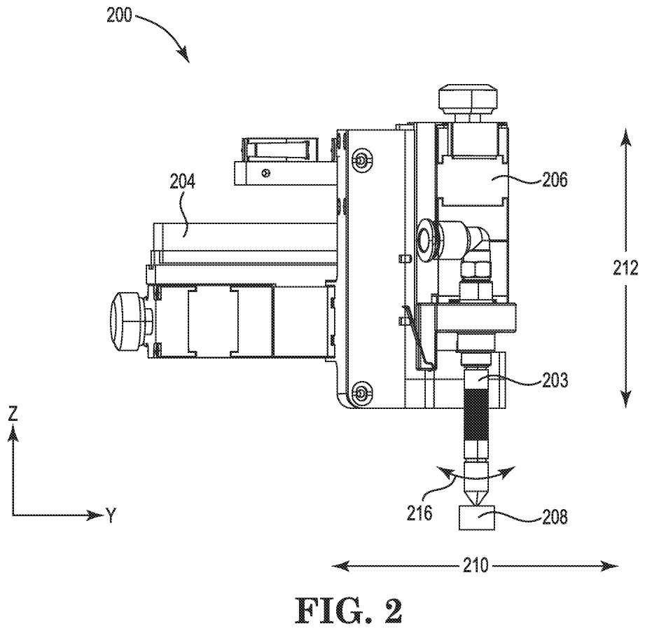

As illustrated in FIG. 1, module 100 can include first linear actuator 104. As used herein, the term “actuator” refers to a component of a machine to move and/or control a mechanism. As used herein, the term “linear actuator” refers to a component of a machine to move and/or control a mechanism in a linear direction. For example, linear actuator 104 can move tool 102 in a linear direction, as is further described in connection with FIG. 2.

Module 100 can include second linear actuator 106, Second linear actuator 106 can move tool 102 in a linear direction that can be different than the linear direction of movement of linear actuator 104. For example, linear actuator 106 can move tool 102 in a direction that may be perpendicular to the direction linear actuator 104 can move tool 102, as is further described in connection with FIG. 2,

Actuators 106, 108 can move tool 102 in a particular linear direction via different mechanisms. For example, actuator 106, 108 can be a mechanical actuator such as a screw, belt driven, wheel and axle, rack-and-pinion, and/or cam mechanical actuator, hydraulic actuator, pneumatic actuator, piezoelectric actuator, linear motor actuator, electro-mechanical actuator, among other types of linear actuators. The type of actuator 106, 108 can depend on space constraints of module 100.

Module 100 can include tool 102. As used herein, the term “tool” refers to an implement to perform mechanical operations. For example, tool 102 can selectively engage and/or selectively disengage from a part.

In some examples, tool 102 can be a nozzle. As used herein, the term “nozzle” refers to a cylindrical spout at an end of a tube to control a flow of a gas, For example, the nozzle can control a flow of a gas at a bottom portion of the nozzle, as oriented in FIG. 1.

Although tool 102 is described above as being a nozzle, examples of the disclosure are not so limited. For example, tool 102 can be any other type of tool to selectively engage and/or selectively disengage from a part, as is further described herein.

Tool 102 can selectively engage a part. As used herein, the term “engage” refers to securing a connection between two objects. For example, tool 102 can secure a connection between tool 102 and a part. Tool 102 can secure the connection by controlling a flow of a gas to create suction via a vacuum, as is further described in connection with FIG. 2.

Tool 102 can selectively disengage a part. As used herein, the term “disengage” refers to removing a connection between two objects. For example, tool 102 can remove a connection between tool 102 and a part. Tool 102 can remove the connection by controlling a flow of a gas to remove suction of a vacuum, as is further described in connection with FIG. 2.

Tool 102 can be connected to linear actuator 104 and linear actuator 106. For example, tool 102 can be moved in a first direction by linear actuator 104 and moved in a second direction by linear actuator 106, as is further described in connection with FIG. 2.

FIG. 2 illustrates a side view of an example of a module 200 of a 3D printer consistent with the disclosure. Module 200 may include a nozzle 203, first linear actuator 204, and second linear actuator 206.

As illustrated in FIG. 2, the side view of module 200 can be oriented in a Y-Z coordinate plane. For example, the Y-coordinate as shown in FIG. 2 can be a width and the Z-coordinate as shown in FIG. 2 can be a height.

Nozzle 203 can be analogous to tool 102, as previously described in connection with FIG. 1. For example, nozzle 203 can selectively engage a part 208 and selectively disengage from the part 208. As used herein, the term “part” refers to an object to be placed in a 3D object during a 3D print job. For example, part 208 can be placed in a 3D object that is being formed by the 3D printer.

Part 208 can be an electrical part. For example, part 208 can be a resistor, capacitor, transistor, antenna, radio frequency identification (RFID) chip, integrated circuit, power adaptor, battery, battery connector, through-hole electronic components, solder paste, vias, universal serial bus (USB), any other electrical parts including circuit components and/or connections thereof, and/or any combination of electrical parts thereof, among other types of electrical parts.

Part 208 can be an optical part. For example, part 208 can be a lens, filter, mirror, and/or any combination thereof, among other types of optical parts.

Part 208 can be a mechanical part. For example, part 208 can be a wire, wire mesh, gear, axle, cam, carbon fiber sheet, and/or any combination thereof, among other types of mechanical parts.

Part 208 can be an aesthetic part. For example, part 208 can be a gem, polished metal, decorative element, etc.

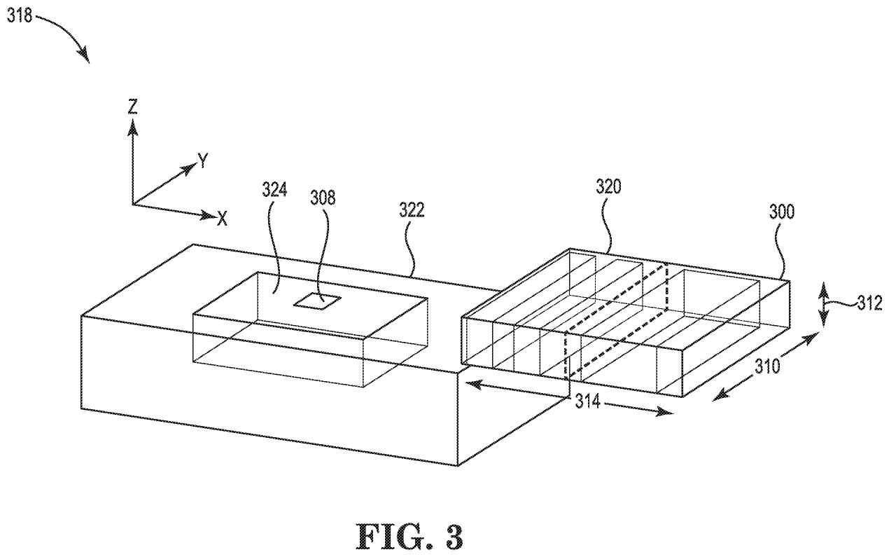

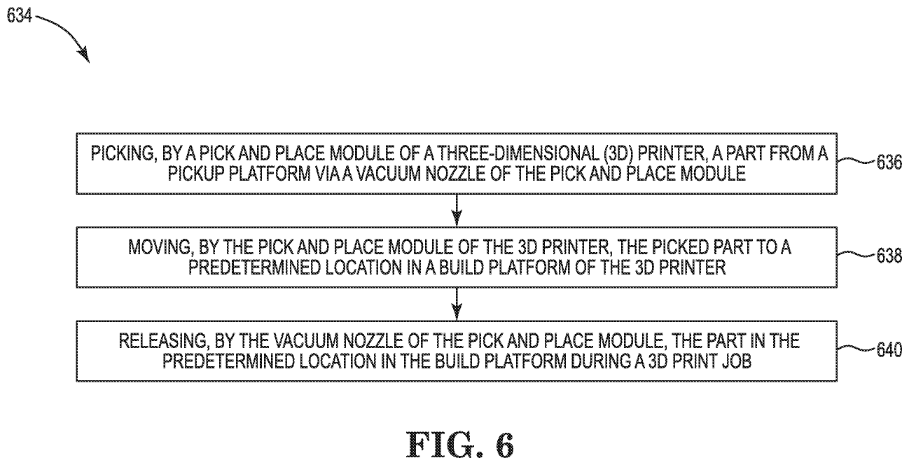

Although part 208 is described as being an electrical part, optical part, mechanical part, and/or aesthetic part, as well as examples thereof, examples of the disclosure are not so limited. For example, part 208 can be any other type of part to be placed in a 3D object during a 3D print job. For instance, a customer of the 3D object being created may request a particular part 208 or parts be included in the 3D object during the 3D print job, and part(s) 208 can be placed in the 3D object during the 3D print job, as is further described in connection with FIGS. 3 and 6.

Nozzle 203 can selectively engage with and/or selectively disengage from part 208 to place part 208 in the 3D object being created during the 3D print job. For example, nozzle 203 can be a vacuum nozzle. As used herein, the term “vacuum” refers to a region with a pressure less than that of atmospheric pressure. For example, nozzle 203 can utilize a vacuum to create a region with a pressure less than that of atmospheric pressure to cause a suction force. As used herein, the term “suction” refers to the production of a partial vacuum by the removal of an amount of air to cause an attraction force towards the space of the partial vacuum. For example, nozzle 203 can cause suction to occur inside nozzle 203 by the removal of an amount of air inside nozzle 203 to cause an attraction force between nozzle 203 and part 208. In other words, nozzle 203 can selectively engage with part 208 by using a suction force. Similarly, nozzle 203 can selectively disengage with part 208 by removing the suction force (e.g., by introducing an amount of air into nozzle 203 to remove the attraction force from the space of the partial vacuum inside nozzle 203).

Nozzle 203 can cause suction to occur inside nozzle 203 by the removal of an amount of air inside nozzle 203 using a vacuum line input to nozzle 203. For example, as indicated in FIG. 2, nozzle 203 can include a vacuum line input. The vacuum line input can be a tube (e.g., rubber, flexible plastic, hard plastic, etc.) that can be connected to a vacuum source that may be external to module 200. The vacuum source can cause the region in nozzle 203 to have a pressure less than that of atmospheric pressure to cause the suction force of nozzle 203. In some examples, the vacuum source may be a component of the 3D printer.

As illustrated in FIG. 2, nozzle 203 includes a tip in the shape of a conical frustum. However, examples of the disclosure are not so limited. For example, the tip of nozzle 203 can include other shapes, Additionally, the tip of nozzle 203 can be interchangeable. For example, the tip of nozzle 203 may be modified based on a part 208 being engaged. For instance, the tip of nozzle 203 may be modified based on a size, shape, and/or weight of part 208 being engaged, among other factors.

Nozzle 203 can be connected to first linear actuator 204 and second linear actuator 206 such that first linear actuator 204 and second linear actuator 206 can move part 208 to a particular location on the 3D object, For example, nozzle 203 is adjustable in a first direction 210 relative to a build platform of the 3D printer via first linear actuator 204, is adjustable in a second direction 212 relative to a build platform of the 3D printer via second linear actuator 206, and is adjustable in a third relative to a build platform of the 3D printer, as is further described herein and in connection with FIG. 3.

Nozzle 203 can be adjustable in first direction 210. As oriented in FIG. 2, module 200 can be oriented in a Y-Z coordinate plane. First direction 210 can correspond with the Y-coordinate. In other words, the nozzle 203 can be moved in a linear direction corresponding to the Y-coordinate by first linear actuator 204. First direction 210 can be a direction relative to a build platform of the 3D printer, as is further described in connection with FIG. 3.

Nozzle 203 can be adjustable in second direction 212. As oriented in FIG. 2, module 200 can be oriented in a Y-Z coordinate plane. Second direction 212 can correspond with the Z-coordinate. In other words, the nozzle 203 can be moved in a linear direction corresponding to the Z-coordinate by second linear actuator 206. Second direction 212 can be a direction relative to a build platform of the 3D printer, as is further described in connection with FIG. 3.

Although not illustrated in FIG. 2 for clarity and so as not to obscure examples of the disclosure, nozzle 203 can be adjustable in a third direction. The third direction can correspond with an X-coordinate. Nozzle 203 can be moved in a linear direction corresponding to an X-coordinate by a third actuator, such as a belt-driven actuator, as is further described in connection with FIG. 3. The third direction can be a direction relative to a build platform of the 3D printer.

Nozzle 203 can be adjustable in a fourth direction 216. The fourth direction can be rotational degrees of freedom about an axis of nozzle 203. Nozzle 203 can be adjustable in fourth direction 216 via a rotational actuator (e.g., not illustrated in FIG. 2 for clarity and so as not to obscure examples of the disclosure), As used herein, the term “rotational actuator” refers to a component of a machine to move and/or control a mechanism in a rotational manner.

Nozzle 203 can selectively engage part 208. For example, part 208 can be a part to be placed in a 3D object being created in a 3D print job. Part 208 can be located in an area outside of a build platform of the 3D printer. Accordingly, linear actuators 204, 206 can move nozzle 203 to part 208 so that nozzle 203 can selectively engage part 208.

Nozzle 203 can selectively disengage from part 208. For example, part 208 can be placed in the 3D object being created in the 3D print job. For example, nozzle 203 can be moved to a location in the build platform of the 3D printer and linear actuators 204, 206 can move nozzle 203 to a predetermined location for part 208. Nozzle 203 can selectively disengage from part 208 when linear actuators 204, 206 have correctly located the predetermined location for part 208 such that part 208 can be placed in the 3D object being created by the 3D print job, as is further described in connection with FIGS. 3 and 6. In some examples, the rotational actuator can rotate part 208 for correct placement at the predetermined location in the 3D object.

FIG. 3 illustrates a perspective view of an example of a system 318 consistent with the disclosure. The system 318 can include module 300, build material carriage 320, and build platform 322. Build platform 322 can include 3D object 324. 3D object 324 can include part 308.

As illustrated in FIG. 3, the perspective view of the system 318 can be oriented in an X-Y-Z coordinate plane. For example, the X-coordinate as shown in FIG. 3 can be a length, the Y-coordinate can be a width, and the Z-coordinate can be a height.

System 318 can be a 3D printer. For example, system 318 can be a multi-jet fusion printer, among other types of 3D printers. The 3D printer of system 318 can deposit build material and a fusing agent in successive layers, and the build material can be fused by a lamp and the fusing agent to create 3D object 324. Part 308 can be placed in 3D object 324, as is further described herein.

The 3D printer can include build platform 322. As used herein, the term “build platform” refers to a build location of the 3D printer, such as a powder bed. For example, the 3D printer may deposit build material in successive layers in build platform 322 to create 3D object 324 in build platform 322.

As used herein, the term “build material” can refer to a material used to create 3D objects in the 3D printer, Build material can be, for example, a powdered semi-crystalline thermoplastic material, a powdered metal material, a powdered plastic material, a powdered composite material, a powdered ceramic material, a powdered glass material, a powdered resin material, and/or a powdered polymer material, among other types of powdered or particulate material.

The 3D printer can include build material carriage 320. As used herein, the term “build material carriage” refers to a device that can include lamps to fuse the build material and/or inkjet printheads. For example, build material carriage 320 can cause build material to be fused to create 3D object 324. In some examples, build material carriage 320 can include build material to deposit to build platform 322. In some examples, build material carriage 320 can include a roller to spread build material in build platform 322.

As previously described in connection with FIGS. 1 and 2, module 300 can include a nozzle. The nozzle can be utilized to pick and/or place part 308, as is further described herein, In other words, module 300 can be a pick and place module of the 3D printer to pick parts from a location external to build platform 322 and place the parts in and/or on a 3D object 324 being created in build platform 322 by the 3D printer, as is further described herein,

Module 300 (e.g., and the nozzle included in module 300) can be adjustable relative to build platform 322 in first direction 310 (e.g., the Y-direction), adjustable relative to build platform 322 in second direction 312 (e.g., the Z-direction), and/or adjustable relative to build platform 322 in third direction 314 (e,g., the X-direction) to pick and/or place part 308. As previously described in connection with FIGS. 1 and 2, module 300 can include a first linear actuator, a second linear actuator, and a third linear actuator. The first linear actuator can adjust the nozzle in first direction 310, the second linear actuator can adjust the nozzle in second direction 312, and the third linear actuator can adjust the nozzle in third direction 314.

As previously described in connection with FIG. 2, part 308 can be included as a component of 3D object 324. For example, 3D object 324 can be a USB drive and part 308 can be a USB connector. In other words, part 308 can be an electrical part to be used in 3D object 324.

Although examples herein describe part 308 as being an electrical part, examples of the disclosure are not so limited. For example, part 308 can be an electrical part, optical part, mechanical part, aesthetic part, and/or any other part to be included in 3D object 324.

As described above, 3D object 324 may be a USB drive. In order to place the USB connector (e.g., part 308) in the USB drive, the 3D printer can first print a portion of 3D object 324. Printing the portion of 3D object 324 can include printing and fusing portions of the 3D object 324 but refraining portions of 3D object 324 in which part 308 is to be located. When a sufficient portion of 3D object 324 is printed, unfused build material can be removed from the location of where part 308 is to be placed, creating a cavity for placement of part 308, as is further described herein.

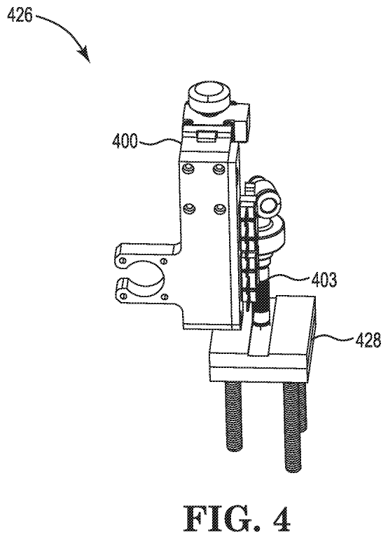

As described above, module 300 can include a nozzle. The nozzle of module 300 can selectively engage part 308 (e.g., the USB connector) from an area outside of build platform 322. For example, the nozzle of module 300 can selectively engage part 308 using suction from a pickup platform (e.g., not illustrated in FIG. 3), further described in connection with FIG. 4.

The nozzle of module 300 can be adjusted in first direction 310 (e.g., in a Y-direction) and adjusted in third direction 314 (e.g., in an X-direction) until the nozzle of module 300 is located above the location in the build platform 322 at which part 308 is to be placed. In other words, the nozzle can be moved over 3D object 324 to locate itself above the location in 3D object 324 at which part 308 is to be placed in 3D object 324,

The nozzle of module 300 can be adjusted in second direction 312 (e.g., in a Z-direction) to place part 308 in 3D object 324. For example, the nozzle of module 300 can be moved “downwards” to place part 308 in the cavity in 3D object 324 created by removing unfused build material from 3D object 324.

The nozzle of module 300 can selectively disengage from part 308 in the location (e.g., the cavity of 3D object 324) in build platform 322 by removing suction. In some examples, selectively disengaging from the component can include providing a short pulse of gas (e.g., a short pulse of positive air pressure) to selectively disengage the part 308 from the nozzle of module 300. The nozzle of module 300 can then be moved “upwards” to move clear of part 308/3D object 324. In an example in which module 300 is not connected with build material carriage 320 and can move independently of build material carriage 320, the module 300 can then be moved in first direction 310 and/or third direction 314 to prevent obstructing build material carriage 320 from continuing the 3D print job of 3D object 324. In other words, after placing part 308, the nozzle and module 300 can be moved to a default location which does not interfere with the operation of build material carriage 320. The movement of module 300 after placing part 308 can allow for the placement of part 308 without interfering with the workflow of the 3D print job.

As illustrated in FIG. 3, a top surface of part 308 can be oriented at a same height as a top surface of 3D object 324, For example, when part 308 is placed in 3D object 324, a continuous surface can be created such that the 3D printer can continue to print 3D object 324. In other words, part 308 can be placed in 3D object 324 and the 3D printer can continue to print 3D object such that part 308 is located inside of 3D object 324,

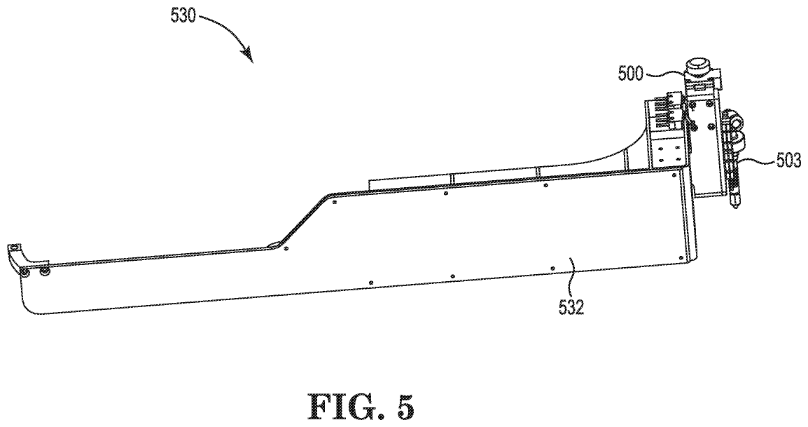

As described above, module 300 (e.g., and the nozzle of module 300) can be adjusted in the third direction (e.g., the X-direction) by an actuator. In some examples, the actuator can be a belt-driven actuator in order to achieve a torque and acceleration to quickly move module 300 to place part 308 in 3D object 324. The actuator can adjust module 300 independently of build material carriage 320. In other words, build material carriage 320 and module 300 are not connected, allowing for faster placement of part 308. However, examples of the disclosure are not so limited. In some examples, module 300 can be connected to build material carriage 320, as is further described in connection with FIG. 5.

Although not shown in FIG. 3, the system can include a controller The controller can include a processing resource (not shown) and a memory resource (not shown). The memory resource can include machine readable instructions to cause a nozzle of a module of a 3D printer to selectively engage a part and selectively disengage from the part.

The processing resource may be a central processing unit (CPU), a semiconductor based microprocessor, and/or other hardware devices suitable for retrieval and execution of the machine-readable instructions stored in a memory resource, The processing resource may fetch, decode, and execute the instructions to adjust the nozzle of the module of the 3D printer via linear actuators and pick and/or place a part in a build platform during a 3D print job. As an alternative or in addition to retrieving and executing the instructions, the processing resource may include a plurality of electronic circuits that include electronic components for performing the functionality of the instructions.

The memory resource may be any electronic, magnetic, optical, or other physical storage device that stores the executable instructions and/or data. Thus, the memory resource may be, for example, Random Access Memory (RAM), an Electrically-Erasable Programmable Read-Only Memory (EEPROM), a storage drive, an optical disc, and the like. The memory resource may be disposed within the controller. Additionally and/or alternatively, the memory resource may be a portable, external or remote storage medium, for example, that allows the controller to download the instructions from the portable/external/remote storage medium.

Modules of 3D printers, according to the disclosure, can allow for automated placement of parts in 3D printed objects without delaying the 3D print job, Parts which may be thicker than a layer thickness of a layer of build material can be incorporated (e.g., embedded) in the 3D object without causing print failures. The parts can be parts which can be connected to conductive traces included in the 3D object. Further, the parts may be quickly placed in an automated way, reducing losses in dimensional accuracy due to temperature losses in thermally prepared parts, reducing and/or eliminating warping of the part and/or 3D object. Accordingly, the speed, accuracy, and viability of placement of parts in 3D objects can be greatly improved, allowing for placement of parts in 3D objects without interfering with the workflow and/or process of applying and/or fusing layers of build material during the 3D print job.

FIG. 4 illustrates a front view of an example of a system 426 of a 3D printer and a pickup platform 428 consistent with the disclosure. The system 426 can include module 400 and pickup platform 428. Module 400 can include nozzle 403.

Module 400 can include nozzle 403. Nozzle 403 can be used to pick a part from a location external to a build platform of the 3D printer and place the part in a location of the build platform of the 3D printer. For example, nozzle 403 can be adjusted relative to the build platform by linear actuators in order to pick and/or place a part.

As illustrated in FIG. 4, module 400 and nozzle 403 can be located in an area outside of the build platform of the 3D printer. For example, nozzle 403 can selectively engage a part from the area outside of the build platform of the 3D printer. Nozzle 403 can selectively engage the part by suction.

The area outside of the build platform of the 3D printer can include a pickup platform 428. As used herein, the term “pickup platform” refers to an area at which parts can be provided for selective engagement by nozzle 403. Nozzle 403 can engage (e.g., pick) the part via suction from pickup platform 428, For example, a part may be desired to be placed in a 3D object, and the part can be provided to pickup platform 428 such that nozzle 403 can selectively engage the part at pickup platform 428. In some examples, a component reel may provide the part to pickup platform 428, although examples of the disclosure are not limited to a component reel. Pickup platform 428 can be included as part of the 3D printer. In some examples, pickup platform 428 can be a platform separate from the 3D printer.

Once nozzle 403 has engaged the part at pickup platform 428, module 400 (e.g., and nozzle 403) can be adjusted so that nozzle 403 and the part are located at a location at which the part is to be placed in the 3D object. As previously described in connection with FIG. 3, nozzle 403 can selectively disengage from the part in the location in the build platform at which the part is to be located in the 3D object. Nozzle 403 can selectively disengage from the part by removing suction. In some examples, selectively disengaging from the component can include providing a short pulse of gas (e.g., a short pulse of positive air pressure) to selectively disengage the part from nozzle 403.

FIG. 5 illustrates a perspective view of a system 530 of a 3D printer and a member 532 consistent with the disclosure. System 530 can include module 500 and member 532. Module 500 can include nozzle 503.

As previously described in connection with FIG. 3, in some examples, module 500 can be connected to the build material carriage of the 3D printer, In such an example, module 500 can be connected to the build material carriage via member 532. As used herein, the term “member” refers to a structural bracket to connect two objects. For example, member 532 can be a member that can connect module 500 with the build material carriage.

Member 532 can connect module 500 with the build material carriage such that module 500 can move with the build material carriage. Accordingly, module 500 can include a first linear actuator and a second linear actuator to adjust module 500 in a first direction and second direction, respectively (e.g., first direction 310, second direction 312, respectively, as previously described in connection with FIG. 3), but does not include a third linear actuator, as the build material carriage can move module 500 in the third direction (e.g., third direction 314, as previously described in connection with FIG. 3).

Member 532 can be designed such that module 500 can be connected to the build material carriage without interfering with components of the build material carriage. For example, member 532 can connect module 500 with the build material carriage without interfering with components to deposit build material in the build platform and/or components to fuse the build material to create the 3D object in the build platform.

Module 500 being connected with the build material carriage can allow for movement of module 500 without an additional actuator since module 500 is connected to the build material carriage, This can allow for faster build times of the 3D object as the movement of module 500 being optimized and streamlined with the movement of the build material carriage.

FIG. 6 illustrates an example of a method 634 consistent with the disclosure. For example, method 634 may be performed by a 3D printer including a module (e.g., module 100, 200, 300, 400, 500, described in connection with FIGS. 1-5, respectively) and nozzle (e.g., tool 102, 203, 403, 503, described in connection with FIGS. 1, 2, 4, and 5, respectively).

At 636, the method 634 includes picking, by a pick and place module of a 3D printer, a part from a pickup platform via a vacuum nozzle of the pick and place module. For example, the vacuum nozzle can create a suction force by engaging a vacuum in the vacuum nozzle. The vacuum nozzle can be moved such that it is in proximity to the part on the pickup platform such that the vacuum nozzle can engage the part via the suction force. The pickup platform can be in an area external to a build platform of the 3D printer, and the part can be provided to the pickup platform such that the nozzle of the pick and place module can engage the part on the pickup platform.

At 638, the method 634 includes moving, by the pick and place module of the 3D printer, the picked part to a predetermined location in a build platform of the 3D printer. For example, the pick and place module can include linear actuators such that the pick and place module can be moved to various locations in the build platform of the 3D printer. The pick and place module can move to a predetermined location in the build platform of the 3D printer to place the part at the predetermined location. For example, the predetermined location can be a location in the 3D object being created by the 3D printer.

The pick and place module can include a first linear actuator, a second linear actuator, and/or a third linear actuator. The first linear actuator can move the nozzle of the pick and place module, the nozzle including the engaged part, in a first direction relative to the build platform (e.g., in a Y-direction, as previously described in connection with FIG. 3). The second linear actuator can move the nozzle of the pick and place module, the nozzle including the engaged part, in a second direction relative to the build platform (e.g., in a Z-direction, as previously described in connection with FIG. 3). The third linear actuator can move the nozzle of the pick and place module, the nozzle including the engaged part, in a third direction relative to the build platform (e.g., in an X-direction, as previously described in connection with FIG. 3). Utilizing the combination of the first, second, and third linear actuators, the pick and place module and the part can be moved to the predetermined location in the build platform of the 3D printer.

At 640, the method 634 includes releasing, by the vacuum nozzle of the pick and place module, the part in the predetermined location in the build platform during a 3D print job. For example, an external vacuum source can be disengaged such that the suction of the vacuum nozzle is disengaged, Disengaging the suction of the vacuum nozzle can cause the part engaged to the nozzle to be disengaged at the predetermined location. For example, the nozzle can disengage from the part when the part is placed in a location in the 3D object being created by the 3D print job of the 3D printer. In some examples, after disengaging the suction of the vacuum nozzle, the method 634 can include providing a short pulse of gas (e.g., a short pulse of positive air pressure) to selectively disengage the part from the nozzle.

As used herein, “a” thing may refer to one, or more than one of such things. For example, “a widget” may refer to one widget, or more than one widget.

The figures follow a numbering convention in which the first digit or digits correspond to the drawing figure number and the remaining digits identify an element or component in the drawing. Similar elements or components between different figures may be identified by the use of similar digits. For example, 203 may reference element “03” in FIG. 2, and a similar element may be referenced as 303 in FIG. 3.

The above specification, examples and data provide a description of the method and applications, and use of the system and method of the present disclosure. Since many examples may be made without departing from the scope of the system and method of the present disclosure, this specification merely sets forth some of the many possible example configurations and implementations.

What is claimed is:

1. A module of a three-dimensional (3D) printer, comprising:
a first actuator;
a second actuator; and
a tool to selectively engage a part and selectively disengage from a part, wherein the tool is connected to the first actuator and the second actuator.

2. The module of claim 1, wherein the tool is adjustable in a first direction relative to a build platform of the 3D printer via the first actuator, wherein the first actuator is a linear actuator.

3. The module of claim 1, wherein the tool is adjustable in a second direction relative to a build platform of the 3D printer via the second actuator, wherein the second actuator is a linear actuator.

4. The module of claim 1, wherein the tool is adjustable in a third direction relative to a build platform of the 3D printer via a third actuator, wherein the third actuator is a linear actuator.

5. The module of claim 1, further comprising a rotational actuator, wherein the tool is connected to the rotational actuator such that the tool is adjustable in a fourth direction via the rotational actuator.

6. The module of claim 1, wherein the tool:
selectively engages the part from an area outside of a build platform of the 3D printer; and
selectively disengages from the part in a location in the build platform.

7. A three-dimensional (3D) printer, comprising:
a build material carriage; and
a pick and place module, wherein the pick and place module includes:
a first linear actuator;
a second linear actuator; and
a vacuum nozzle connected to the first linear actuator and the second linear actuator;
wherein the vacuum nozzle of the pick and place module is adjustable in a first direction via the first linear actuator, adjustable in a second direction via the second linear actuator, and adjustable in a third direction such that the vacuum nozzle is to pick a part and place the part in a build platform during a 3D print job.

8. The 3D printer of claim 7, wherein the 3D printer further includes a pickup platform.

9. The 3D printer of claim 8, wherein the vacuum nozzle is to pick the part via suction from the pickup platform.

10. The 3D printer of claim 7, wherein the vacuum nozzle is to place the part at a location in the build platform during the 3D print job by removing suction.

11. The 3D printer of claim 7, wherein the pick and place module is connected to a build material carriage via a member such that the pick and place module is adjustable in the third direction via the build material carriage.

12. A method, comprising:
picking, by a pick and place module of a three-dimensional (3D) printer, a part from a pickup platform via a vacuum nozzle of the pick and place module;
moving, by the pick and place module of the 3D printer, the picked part to a predetermined location in a build platform of the 3D printer; and
releasing, by the vacuum nozzle of the pick and place module, the part in the predetermined location in the build platform during a 3D print job.

13. The method of claim 12, wherein the method includes picking the part from the pickup platform via suction by engaging a vacuum of the vacuum nozzle.

14. The method of claim 13, wherein the method includes releasing the part in the predetermined location by disengaging the vacuum of the vacuum nozzle.

15. The method of claim 12, wherein moving the part to the predetermined location includes at least one of:
moving, via a first linear actuator of the pick and place module, the nozzle including the picked part in a first direction relative to the build platform;
moving, via a second linear actuator of the pick and place module, the nozzle including the picked part in a second direction relative to the build platform; and
moving, via a third linear actuator of the pick and place module, the nozzle including the picked part in a third direction relative to the build platform.
